(19) United States
(12) Patent Application Publication
(10) Pub. No.: US 2009/0003770 A1
(43) Pub. Date: Jan. 1, 2009

(54) VERTICAL OPTICAL COUPLING STRUCTURE

(75) Inventors: Douglas M. Gill, South Orange, NJ (US); Sanjay Patel, New Providence, NJ (US); Mahmoud Rasras, Berkeley Heights, NJ (US)

Correspondence Address: HITT GAINES, PC;ALCATEL-LUCENT, PO BOX 832570, RICHARDSON, TX, 75083, US

(73) Assignee: Alcatel-Lucent, Murray Hill, NJ (US)

(21) Appl. No.: 11/771,272

(22) Filed: Jun. 29, 2007

(51) Int. Cl. G02B 6/30; C23F 1/00

(52) U.S. Cl. 385/49; 216/2

(57) ABSTRACT

The present disclosure provides an apparatus, method of manufacturing an apparatus, and method for operation of the same. The apparatus, in one embodiment, includes an optical coupling structure disposed within a cladding region, wherein the optical coupling structure includes a first guiding portion and a second guiding portion. In this embodiment, the first guiding portion is located on a first plane and tapers from a first greater width to a first lesser width in a first direction. The second guiding portion, in turn, is located on a second different plane and tapers from a second greater width to a second lesser width in a second opposite direction.

### U.S. GOVERNMENT

The U.S. Government has a paid-up license in this disclosure and the right in limited circumstances to require the patent owner to license others on reasonable terms as provided for by the terms of Contract No. HR0011-05-C-0027 awarded by DARPA under EPIC.

### TECHNICAL FIELD

The present disclosure is directed, in general, to an optical apparatus and, more specifically, to a vertical optical coupling structure, method for manufacture therefore, and method for operating the same.

### BACKGROUND

Optical fiber communication systems are important components in the telecom industry. Such systems typically comprise long lengths of fiber for transmission and often use planar waveguide devices to perform a variety of processes such as filtering, multiplexing signal channels, demultiplexing, compensating chromatic dispersion and compensating polarization dispersion.

A planar waveguide device, in contrast to its optical fiber counterpart, may be formed from a layer of silicon surrounded by a silicon dioxide cladding layer. The core is typically of rectangular cross section. The core is formed, as by etching of a masked surface, into a patterned configuration that performs a desired function. In order to permit small radius curves, and thus compact functionality, the difference in refractive index of the planar waveguide core and the index of the cladding is typically substantially greater than the corresponding difference for optical fibers. The planar waveguide is said to be high delta where delta (A) is given by the core index less the cladding index, all divided by the core index.

### SUMMARY

Problems exist in coupling light within planar waveguides. Problems particularly exist in coupling light between two different vertically placed planar waveguides. For example, the narrow spacing between the two different vertically placed planar waveguides prevents the optical mode from being fully coupled from one vertical planar waveguide to the other. This is particularly evident when high index materials are used as the guiding layers, such as when silicon or amorphous silicon layers are used. The mismatch in optical mode additionally presents a device that is intolerant to process variations or misalignment between the vertically placed planar waveguides. To address these deficiencies, provided is an apparatus, method of manufacture therefore, and method for operation of the same.

The apparatus, in one embodiment, includes an optical coupling structure disposed within a cladding region, wherein the optical coupling structure includes a first guiding portion and a second guiding portion. In this embodiment, the first guiding portion is located on a first plane and tapers from a first greater width to a first lesser width in a first direction. The second guiding portion, in turn, is located on a second different plane and tapers from a second greater width to a second lesser width in a second opposite direction.

Provided, in another embodiment, is a method for operating an apparatus. This method (e.g., without limitation) includes sending an optical signal through a core of an optical fiber, and coupling the optical signal from the core of the optical fiber to a core of a planar waveguide using an optical coupling structure disposed within a cladding region. The optical coupling structure, in this embodiment, includes a first guiding portion and a second guiding portion. For example, the first guiding portion is located on a first plane and tapers from a first greater width to a first lesser width in a first direction. The second guiding portion, in turn, is located on a second different plane and tapers from a second greater width to a second lesser width in a second opposite direction.

Further provided is a method for manufacturing an apparatus. This method of manufacture, in one embodiment, includes: 1) providing a first layer of high refractive index material over a substrate, 2) patterning the first layer of high refractive index material into a first guiding portion, the first guiding portion being located on a first plane and tapering from a first greater width to a first lesser width in a first direction, 3) forming a second layer of high index material over the first guiding portion, and 4) patterning the second layer of high refractive index material into a second guiding portion, the second guiding portion being located on a second different plane and tapering from a second greater width to a second lesser width in a second opposite direction.

### BRIEF DESCRIPTION OF THE DRAWINGS

The various embodiments can be understood from the following detailed description, when read with the accompanying figures. Various features may not be drawn to scale and may be arbitrarily increased or reduced in size for clarity of discussion. Reference is now made to the following descriptions taken in conjunction with the accompanying drawings, in which:

FIGS. 1A thru 1D illustrate various different views of an apparatus manufactured in accordance with this disclosure;

FIG. 2 illustrates an alternative embodiment of an apparatus manufactured in accordance with the disclosure;

FIGS. 3A thru 8D illustrate one embodiment for manufacturing an apparatus in accordance with the disclosure;

FIG. 9 illustrates an optical communications system, which may form one environment in which an apparatus constructed according to the disclosure, may be used; and

FIG. 10 illustrates an alternative embodiment of an optical communication system.

### DETAILED DESCRIPTION

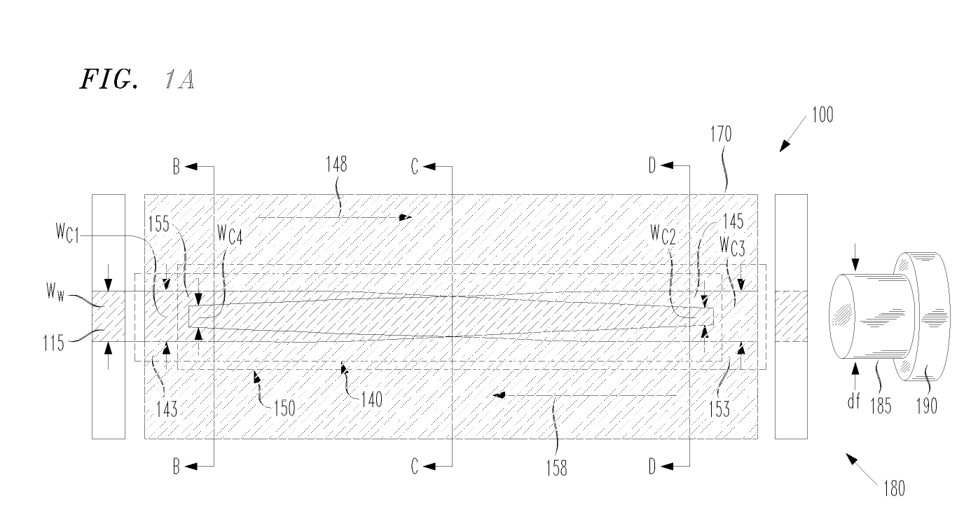

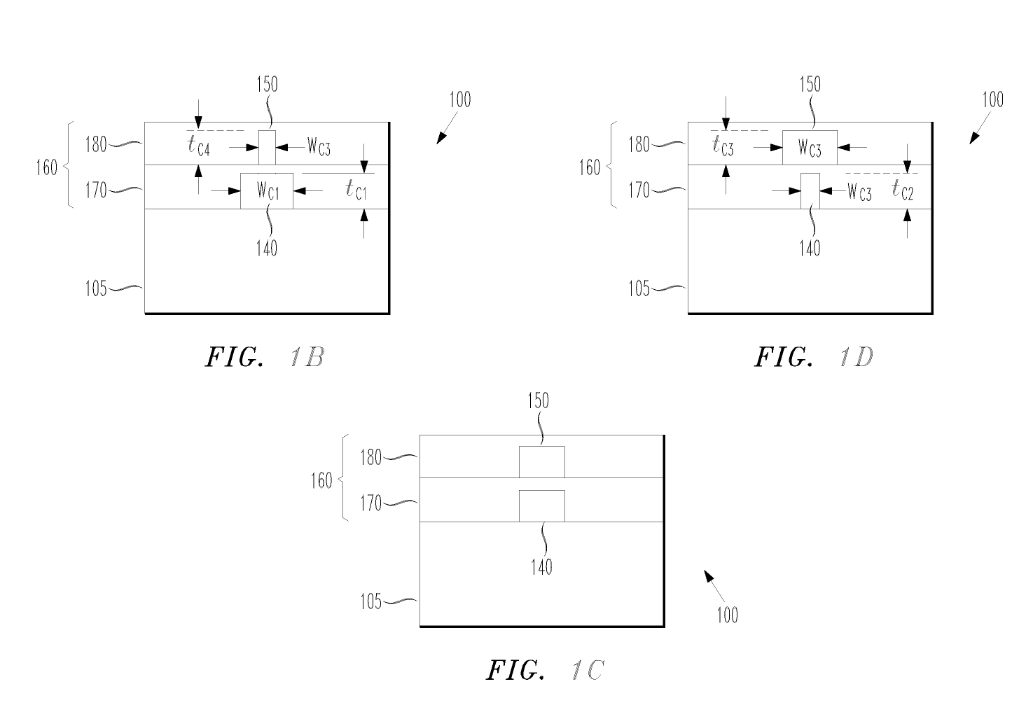

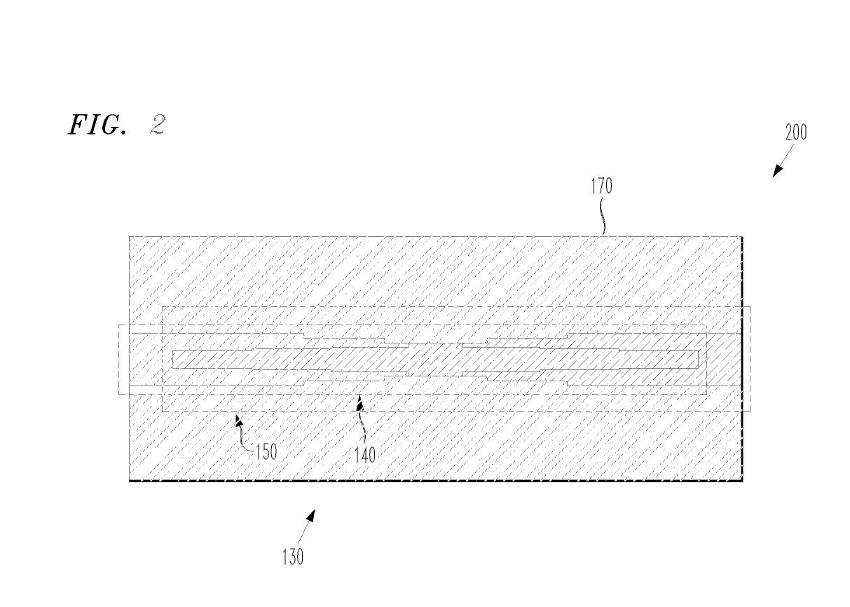

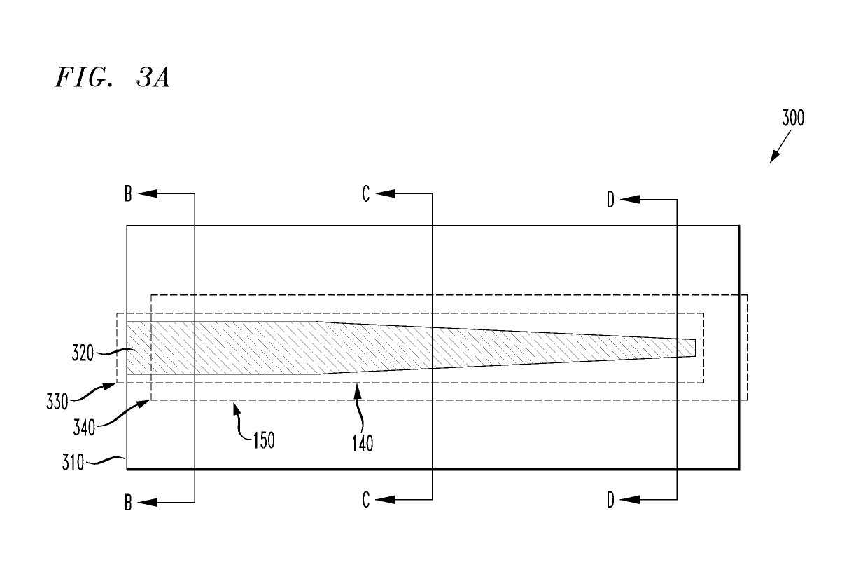

FIGS. 1A thru 1D illustrate various different views of an apparatus 100 manufactured in accordance with this disclosure. The apparatus 100 of FIGS. 1A thru 1D includes a planar waveguide device 110 coupled to an optical fiber 180 in accordance with the disclosure. In the given embodiment of FIGS. 1A thru 1D, an optical coupling structure 130, which is formed over a substrate 105, is configured to assist in coupling the planar waveguide device 110 to the optical fiber 180, and vice versa.

The planar waveguide device 110, in the illustrated embodiment, extends axially and has a core 115 of transverse dimensions, including a width (w_{w}) and a thickness. In one example embodiment the width (w_{w}) ranges from about 400 nm to about 2000 nm, for instance about 500 nm. In another example embodiment, the thickness ranges from about 180 nm to about 250 nm, for instance about 200 nm. Accordingly, the core 115 of the planar waveguide device 110 has a cross-sectional area, for example ranging from about 7.2E4 nm² to about 5.0E5 nm² in certain embodiments.

The optical fiber 180, in the example embodiment, is a conventional single mode fiber. For example, the optical fiber 180 might be a single mode fiber having a fiber core 185 surrounded by one or more cladding layers 190. In the illustrated embodiment, the fiber core 185 has a diameter (d_{f}) for example ranging from about 6000 nm to about 10000 nm. In one specific embodiment, the fiber core 185 has a diameter (d_{f}) around about 8200 nm. Accordingly, the fiber core 185 has a cross-sectional area, for example ranging from about 2.8E7 nm² to about 7.9E7 nm² in certain embodiments. Other diameters, and thus cross-sectional areas may nonetheless also be used.

Positioned between the planar waveguide device 110 and the optical fiber 180 is the optical coupling structure 130. The optical coupling structure 130, in the embodiment of FIGS. 1A thru 1D, includes a first guiding portion 140 and a second guiding portion 150. The first guiding portion 140, in the example embodiment shown, is located on a first plane and the second guiding portion 150 is located on a second different plane. For example, the first guiding portion 140 is located on a first vertical plane and the second guiding portion 150 is located on a different vertical plane in the embodiment of FIGS. 1A thru 1D. Additionally, in one embodiment, a first centerline of the first guiding portion 140 (e.g., taken along the length of the first guiding portion 140) and a second centerline of the second guiding portion 150 (e.g., taken along the length of the second guiding portion 150) are in a third plane different from the first and second planes. For example, in the illustrated embodiment of FIGS. 1A thru 1D, the first and second guiding portions 140, 150, are located directly above/below one another, thus the third plane is normal to the first and second planes.

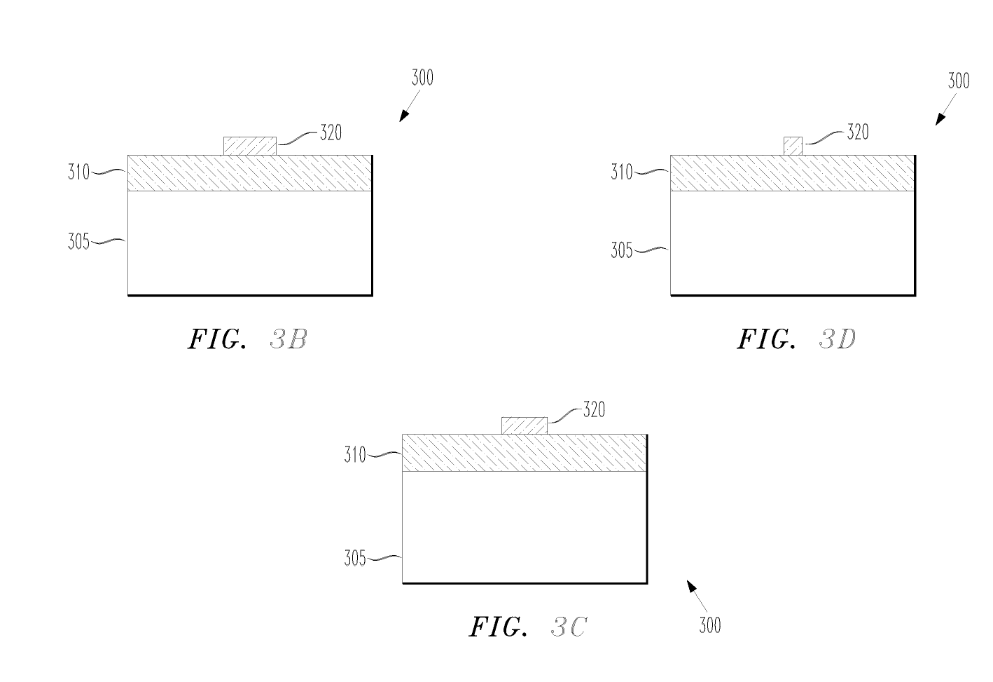

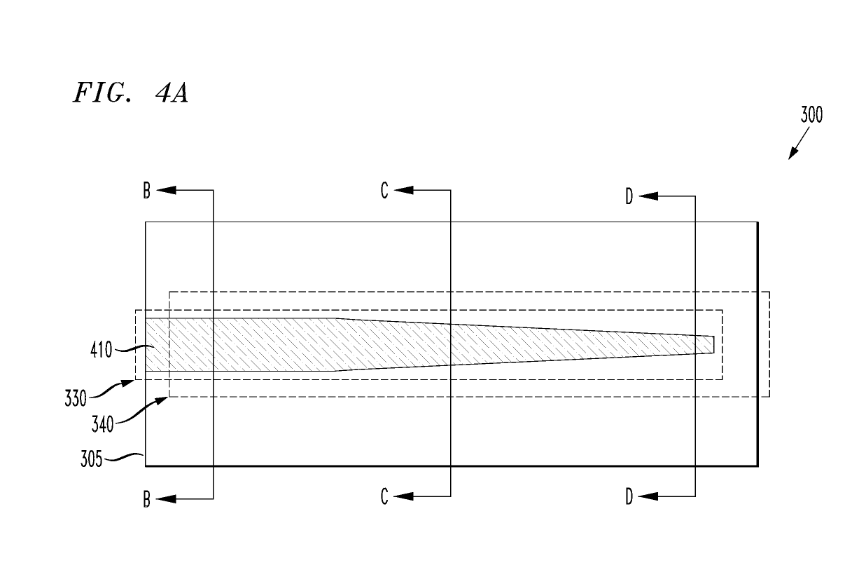

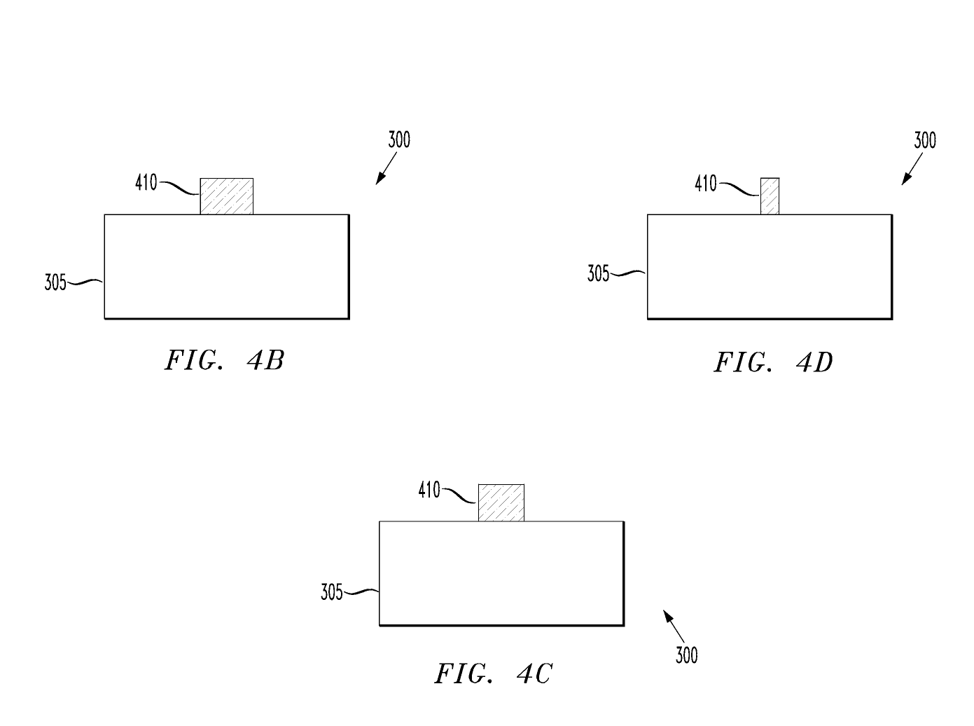

The first guiding portion 140 includes a first end 143 and a second end 145. In accordance with the disclosure, the first guiding portion 140 tapers from a first greater width (w_{c1}) at the first end 143 to a first lesser width (w_{c2}) at the second end 145. This tapering occurs in a first direction 148. In one example embodiment, the taper of the first guiding portion 140 is an adiabatic taper. In other embodiments, such as shown in FIG. 2 discussed below, the taper of the first guiding portion 140 is not an adiabatic taper (e.g., contains discrete sections).

The first greater width (w_{C1}) of the first end 143 and the first lesser width (W_{C2}) of the second end 145 may each vary. For example, in one embodiment the first greater width (w_{C1}) ranges from about 400 nm to about 2000 nm, for instance about 500 nm. Alternatively, the first lesser width (w_{C2}) ranges from about 50 nm to about 350 nm, for instance about 130 nm. While specific ranges of widths have been given in one embodiment, the first greater width (w_{C1}) and first lesser width (w_{C2}) may vary outside of these ranges.

The first end 143 of the first guiding portion 140 may have a thickness (t_{C1}), whereas the second end 145 of the first guiding portion 140 may have a thickness (t_{C2}). In one embodiment, the thickness (t_{C1}) ranges from about 180 nm to about 250 nm, for instance about 200 nm, and the thickness (t_{C2}) ranges from about 180 nm to about 250 nm, for instance about 200 nm. In an alternative embodiment, the thickness (t_{C1}) and the thickness (t_{C2}) are the same, and thus substantially fixed along the first guiding portion 140. The term “substantially fixed”, as used herein, means the thickness is the same except for minor variations (e.g., less than about 5% variation across the entire length thereof). Nonetheless, in the embodiment of FIGS. 1A thru 1D, the first guiding portion 140 has an adiabatically (e.g., gradual) decreasing width from the first end 143 to the second end 145, but has a same thickness from the first end 143 to the second end 145 (e.g., an entire length of the first guiding portion 140 has a same thickness).

The second guiding portion 150 includes a first end 153 and a second end 155. In accordance with the disclosure, the second guiding portion 150 tapers from a second greater width (w_{c3}) at the first end 153 to a second lesser width (W_{c4}) at the second end 155. This tapering occurs in a second opposite direction 158. In one example embodiment, the taper of the second guiding portion 150 is also an adiabatic taper. In other embodiments the taper of the second guiding portion 150 is not an adiabatic taper (e.g., contains discrete sections).

The second greater width (W_{C3}) of the first end 153 and the second lesser width (W_{C4}) of the second end 155 may each vary. For example, in one embodiment the second greater width (W_{C3}) ranges from about 400 nm to about 2000 nm, for instance about 500 nm. Alternatively, the second lesser width (W_{C4}) ranges from about 50 nm to about 350 nm, for instance about 130 nm. While specific ranges of widths have been given in one embodiment, the second greater width (w_{C3}) and second lesser width (w_{C2}) may vary outside of these ranges.

The first end 153 of the second guiding portion 150 may have a thickness (t_{C3}), whereas the second end 155 of the second guiding portion 140 may have a thickness (t_{C4}). In one embodiment, the thickness (t_{C3}) ranges from about 180 nm to about 250 nm, for instance about 200 nm, and the thickness (t_{C4}) ranges from about 180 nm to about 250 nm, for instance about 200 nm. In an alternative embodiment, the thickness (t_{C3}) and the thickness (t_{C4}) are the same, and thus substantially fixed along the second guiding portion 150. In yet another embodiment, the thicknesses of the first and second guiding portions 140, 150, are the same, and thus fixed at a given value. Nonetheless, in the embodiment of FIGS. 1A thru 1D, the second guiding portion 150 has an adiabatically (e.g., gradual) decreasing width from the first end 153 to the second end 155, and has a same thickness from the first end 153 to the second end 155.

With reference to FIGS. 1B thru 1D, the optical coupling structure 130, for example consisting of the first guiding portion 140 and the second guiding portion 150, is located within a cladding region 160. The cladding region 160 and the substrate 110 would collectively form a low refractive index cladding, which would surround the first and second guiding portions 140, 150. The low refractive index cladding, would thus help confine the signal within the first and second guiding portions 140, 150.

The cladding region 160 illustrated in FIGS. 1B thru 1D includes a first cladding material layer 170 and a second cladding material layer 180. The first cladding material layer 170, in one embodiment, comprises a low refractive index material, for example as opposed to the higher refractive index first and second guiding portions 140, 150. In one example embodiment, the first cladding material layer 170 comprises silicon dioxide. For example, a silicon dioxide layer formed to a thickness ranging from about 220 nm to about 400 nm, among others, could be used. In this embodiment, a portion of the first cladding material layer 170 would exist between the first and second guiding portions 140, 150. For example, this portion might have a thickness ranging from about 20 nm to about 150 nm, in one embodiment.

The second cladding material layer 180 might be located over the second guiding portion 150. In this embodiment, the second cladding material layer 180 might comprise a similar material as the first cladding material layer 170, and thus comprise silicon dioxide. In other embodiments the first and second cladding material layers 170, 180 might comprise different materials. The second cladding material layer 180 might be formed to a thickness ranging from about 1500 nm to about 3000 nm, and above, among others.

FIG. 2 illustrates an alternative embodiment of an apparatus 200 manufactured in accordance with the disclosure. The apparatus 200 of FIG. 2 is similar to the apparatus 100 of FIGS. 1A thru 1D, with the exception of a few minor details. Accordingly, similar reference numerals have been used to indicate similar features. The apparatus 200 of FIG. 2 differs from the apparatus 100 of FIGS. 1A thru 1D in that the first and second guiding portions 140, 150 of FIG. 2 have a step-function taper and the first and second guiding portions 140, 150 of FIGS. 1A thru 1D have an adiabatic taper. Those skilled in the art understand the alterations that might need be made to provide the illustrated step-function.

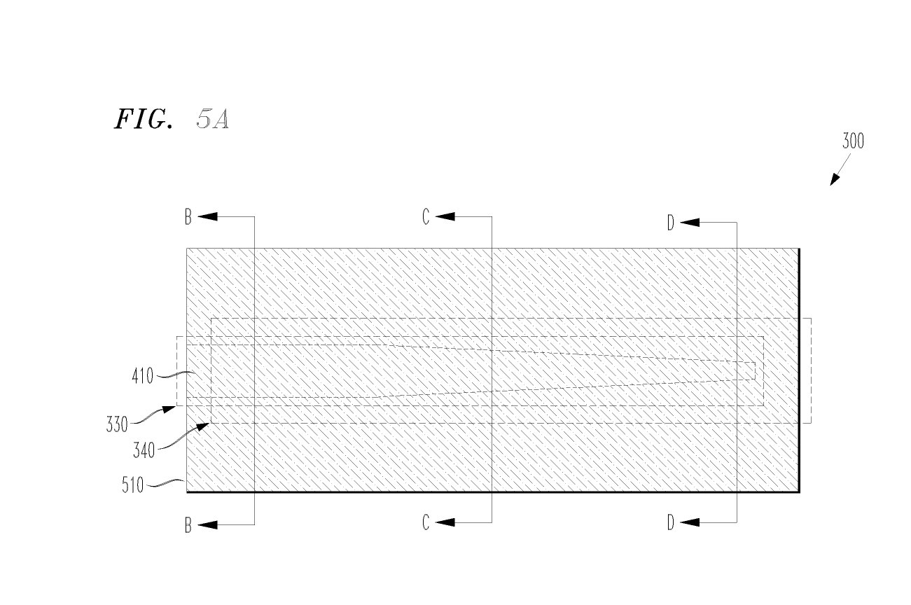

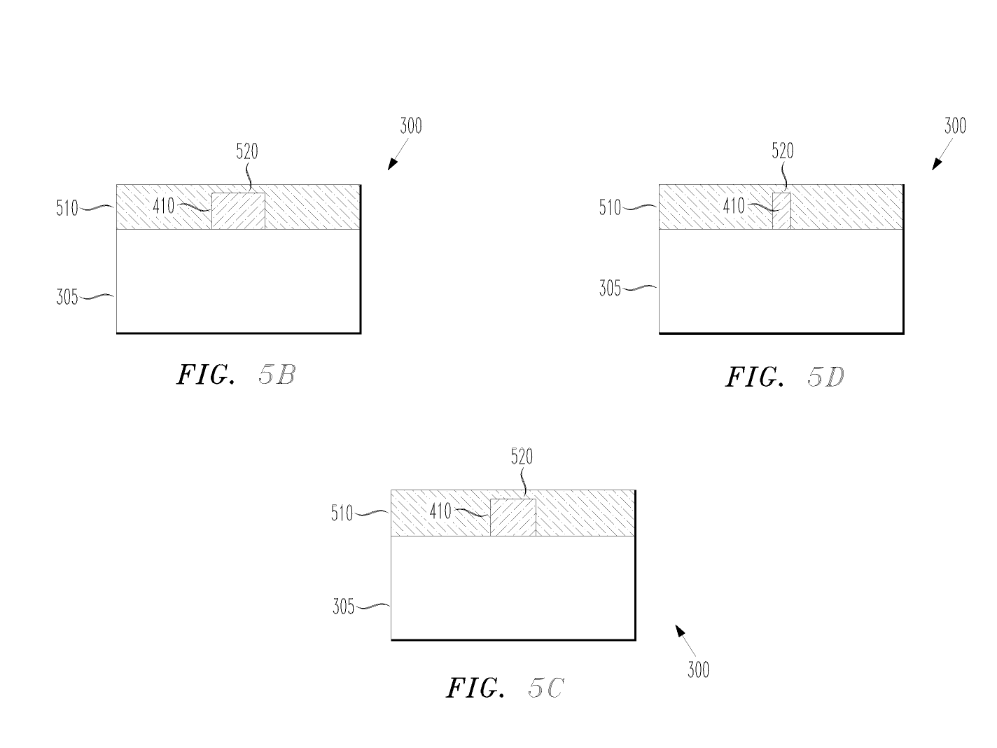

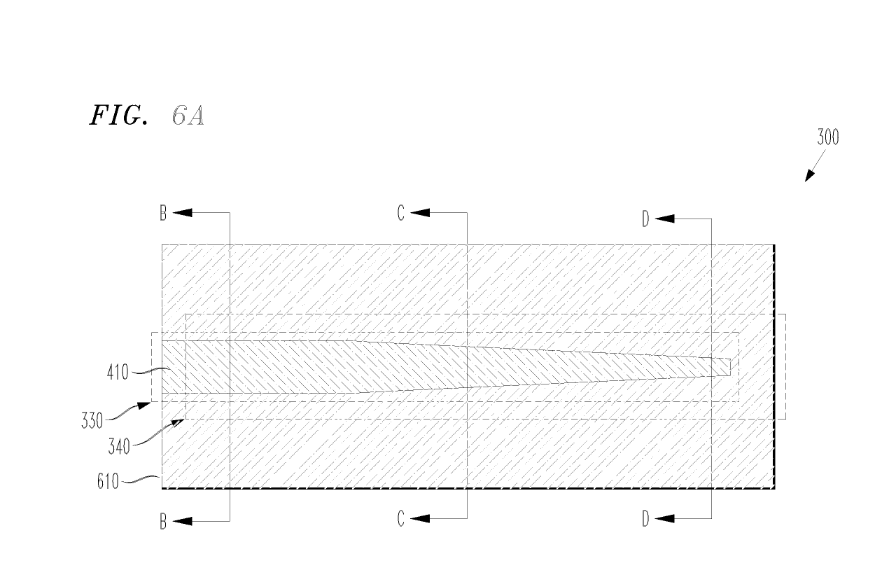

FIGS. 3A thru 8D illustrate one embodiment for manufacturing an apparatus in accordance with the disclosure. FIGS. 3A thru 3D illustrate various views of an apparatus 300 at an initial stage of manufacture. The apparatus 300 of FIGS. 3A thru 3D includes a substrate 305. The substrate 305 may comprise many different materials or combination of materials and remain within the purview of the disclosure. In one embodiment, however, the substrate 305 comprises a low refractive index optical cladding layer, for example silicon dioxide.

The thickness of the substrate 305 may vary greatly. Nevertheless, one particular embodiment uses a thick substrate 305, for example a substrate 305 thickness greater than about 3500 nm. In yet an even different embodiment, the thickness is greater than about 5000 nm. These thicknesses are in contrast to traditional substrates, which might include thicknesses of about 3000 nm or less. Nevertheless, thinner substrates 305 may also be used.

Located over the substrate 305 is a higher refractive index core layer 310. The term “higher” is a relative term, for example as compared to the layers proximate thereto. In this parlance, the term higher is as it would relate to the refractive index of the substrate 305 thereunder. In one particular embodiment, the higher refractive index core layer 310 comprises silicon, as opposed to silica. The higher refractive index core layer 310 has a thickness ranging from about 180 nm to about 250 nm, and more particularly about 200 nm, and covers the entire substrate 305. Nevertheless, other thicknesses could be used.

Those skilled in the art understand the processes that might be used to form each of the substrate 305 and higher refractive index core layer 310. In one embodiment, however, the substrate 305 is formed by low-pressure steam oxidation of silicon followed by an anneal. Then, the higher refractive index core layer 310 is deposited on the substrate 305, for example by Plasma Enhanced Vapor Deposition (PECVD) or Low Pressure Chemical Vapor Deposition (LPCVD). In an alternative embodiment, the substrate 305 and higher refractive index core layer 310 are formed as a part of a silicon-on-insulator (SOI) substrate.

Positioned and patterned over the higher refractive index core layer 310 is a first masking layer 320. The first masking layer 320 may comprise a conventional photoresist layer, conventional hardmask layer or combination of the two. The first masking layer 320, in the embodiment of FIGS. 3A thru 3D, protects a first guiding region 330 of the higher refractive index core layer 310, while exposing remaining portions thereof, including a second guiding region 340. The first masking layer 320 may be formed and patterned using conventional lithography steps.

FIGS. 4A thru 4D illustrate the apparatus 300 of FIGS. 3A thru 3D after using the first masking layer 320 to etch the exposed higher refractive index core layer 310, thus leaving a first guiding portion 410. In this embodiment, a conventional silicon etch is used to define the resulting first guiding portion 410. For example, a timed silicon reactive ion etch could be used in one embodiment. In another embodiment, the etch chemistry could be chosen such that it stops when it reaches the substrate 305. Nevertheless, other conventional isotropic or anisotropic etches, whether based upon time or etch chemistry, could be used. After defining the first guiding portion 410, the first masking layer 320 could be removed using conventional processes.

FIGS. 5A thru 5D illustrate the apparatus 300 of FIGS. 4A thru 4D after forming a first cladding material layer 510 over the first guiding portion 410. In the example embodiment of FIGS. 5A thru 5D, the first cladding material layer 510 has a lower index of refraction than the first guiding portion 410. The term “lower” in this instance, is also a relative term, and thus relates to the layers located proximate thereto. Accordingly, the first cladding material layer 510 has a lower refractive index than the first guiding portion 410. For instance, in those embodiments wherein the first guiding portion 410 comprises silicon, the material layer 510 might comprise silicon dioxide, among others, which has a lower index of refraction than the silicon first guiding portion 410.

The material layer 510, in the illustrated embodiment, is formed to a final thickness ranging from about 220 nm to about 300 nm. In certain embodiments, it is important that the final thickness of the material layer 510 me greater than a thickness of the first guiding portion 410. Nevertheless, the material layer 510 may comprise many different thicknesses while staying within the scope of the present disclosure.

The material layer 510 may be formed using various different processes. However, in one embodiment the material layer 510 is deposited to an initial thickness using a conventional CVD process, and thereafter polished to result in the final thickness discussed above. The polishing (e.g., chemical mechanical polishing in one embodiment) of the material layer 510 is designed to provide a substantially smooth surface. Those skilled in the art understand these two processes, as well as any modifications that might be made thereto.

FIGS. 6A thru 6D illustrate the apparatus 300 of FIGS. 5A thru 5D after forming a second higher refractive index core layer 610 over the material layer 510. In one particular embodiment, the second higher refractive index core layer 610 comprises silicon, similar to the higher refractive index core layer 310. The second higher refractive index core layer 610 has a thickness ranging from about 180 nm to about 250 nm, and more particularly about 200 nm, and covers the entire material layer 510. Nevertheless, other thicknesses could be used.

Those skilled in the art understand the processes that might be used to form the second higher refractive index core layer 610. In one example embodiment, however, a process similar to that used to form the higher refractive index core layer 310 is used to manufacture the second higher refractive index core layer 610. Nevertheless, other embodiments exist wherein the process to form each of these layers is different.

FIGS. 7A thru 7D illustrate the apparatus 300 of FIGS. 6A thru 6D after using a second masking layer (not shown) to etch the exposed second higher refractive index core layer 610, thus leaving a second guiding portion 710. The process for forming the second masking layer and thereafter using the second masking layer to define the second guiding portion 710 is similar to that discussed above with respect to FIGS. 3A thru 4D. Accordingly, no further detail is warranted.

FIGS. 8A thru 8D illustrate the apparatus 300 of FIGS. 7A thru 7D after forming a second cladding material layer 810 over the second guiding portion 710. In the example embodiment shown, the second cladding material layer 810 fully surrounds the second guiding portion 710, and thus contacts the first cladding material layer 510. The second cladding material layer 810 may comprise similar materials and be formed using similar process as discussed above with respect to the first cladding material layer 510.

The first cladding material layer 510 and the second cladding material layer 810 collectively form a cladding region 820. This cladding region 820, in conjunction with the substrate 305, forms a cladding for the first and second guiding portions 410, 710. Accordingly, the cladding region 820 and the substrate 305 help confine a signal traveling down the first and second guiding portions 410, 710, therein.

The apparatus 300 resulting from the manufacturing process of FIGS. 3A thru 8D may, in certain embodiments, be similar to the apparatus 100 illustrated in FIGS. 1A thru 1D. For example, the first and second guiding portions 410, 710 of FIGS. 8A thru 8D may have similar configurations, widths, and thicknesses as the first and second guiding portions 140, 150 of FIGS. 1A thru 1D. In an alternative embodiment, however, the first and second guiding portions 410, 710 of FIGS. 8A thru 8D may have dissimilar configurations, widths, and thicknesses as the first and second guiding portions 140, 150 of FIGS. 1A thru 1D, as long as they are within the purview of the present disclosure.

An apparatus manufactured according to this disclosure, as opposed to many of its predecessors, allows for efficient coupling across different vertical optical layer stacks. Additionally, it enables appropriate (e.g., full in one embodiment) coupling between the layers, particularly when the vertical spacing between layers is small (e.g., about 20 nm to about 50 nm) in comparison to a traditional spacing range of about 150 nm to about 250 nm. Moreover, an apparatus manufactured according to this disclosure is more process tolerant.

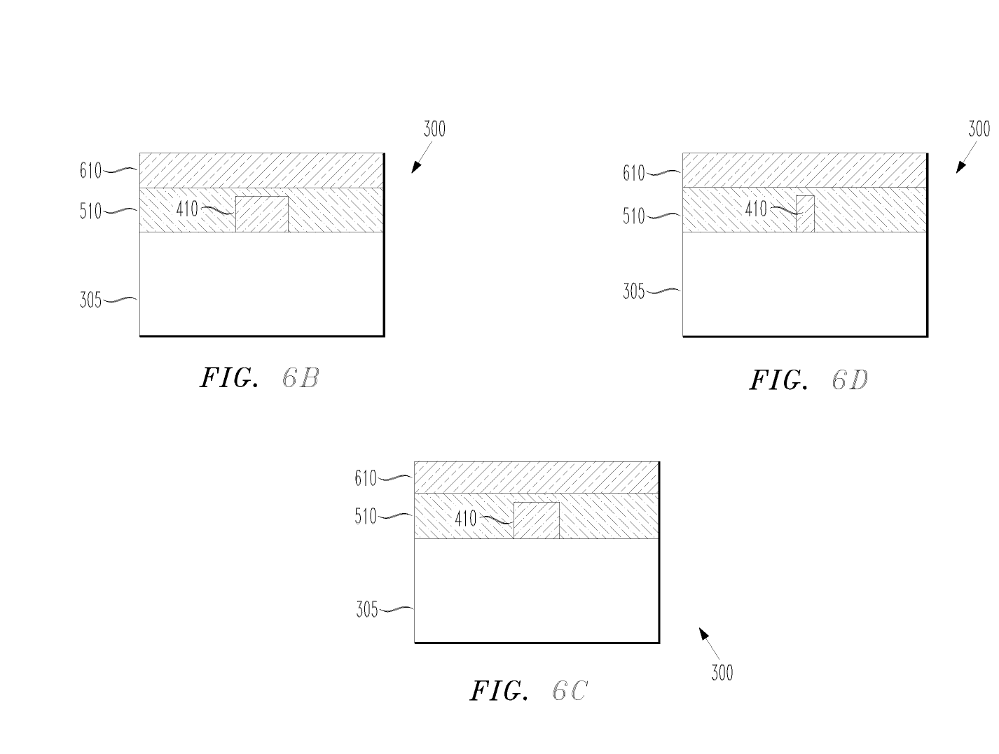

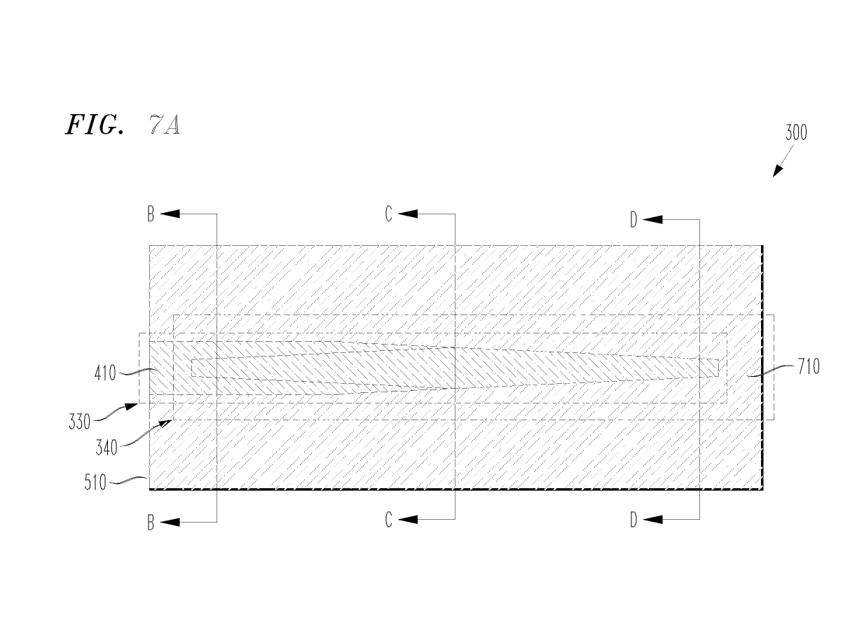

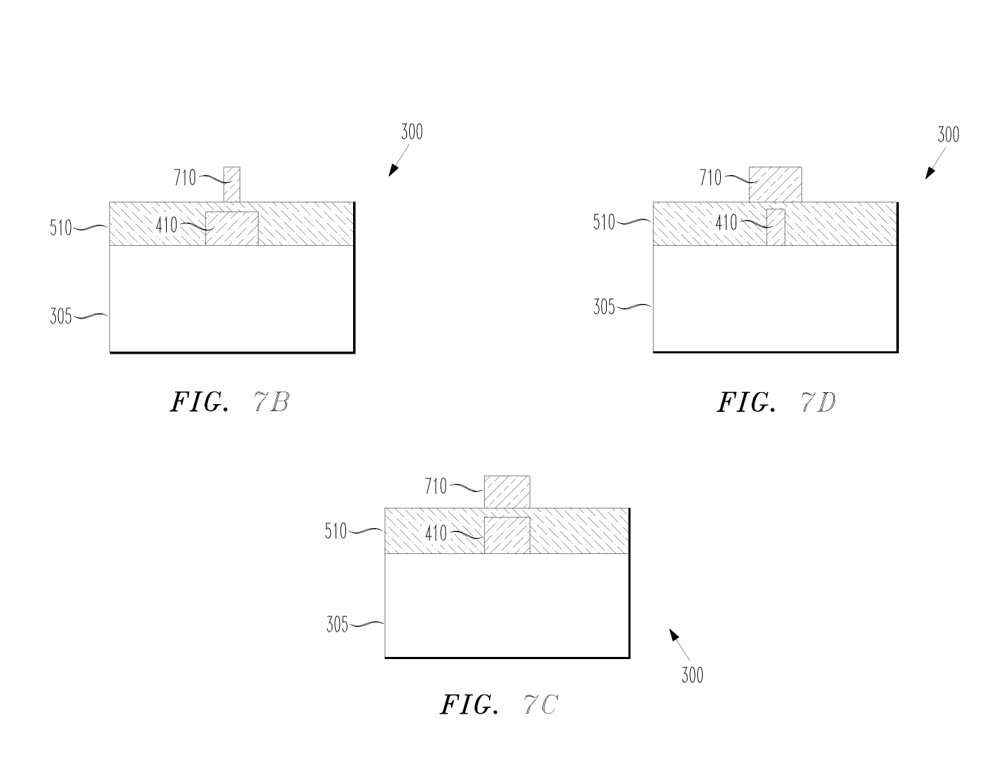

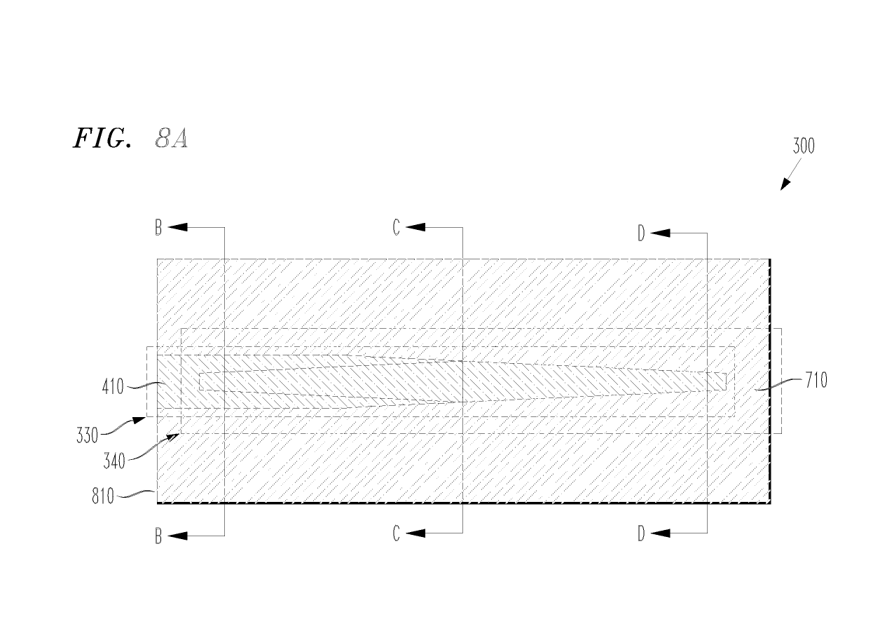

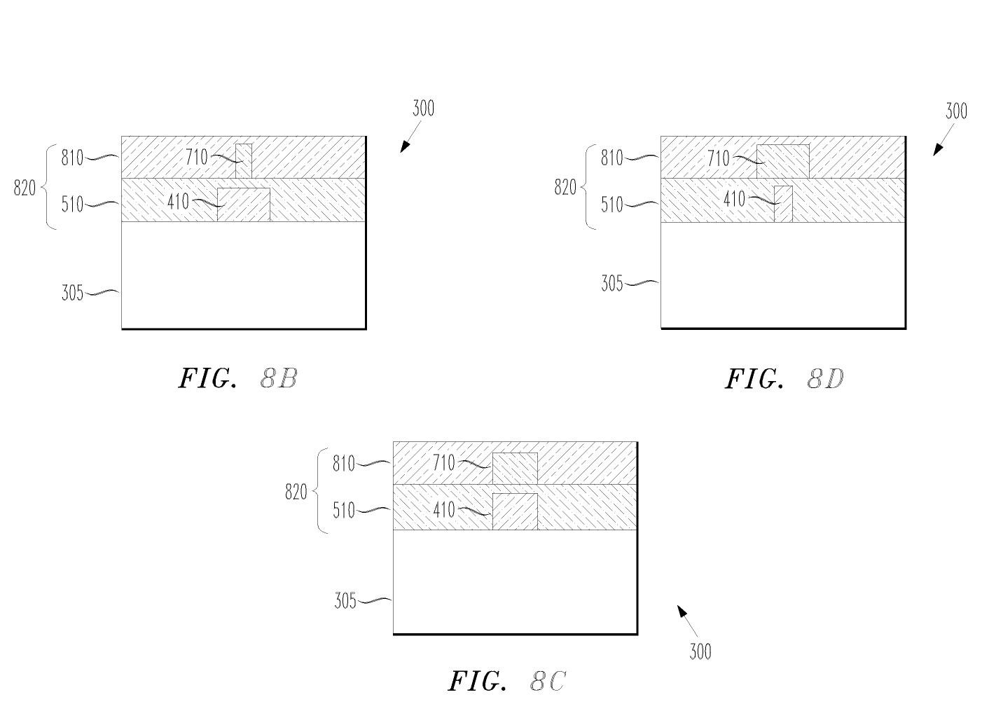

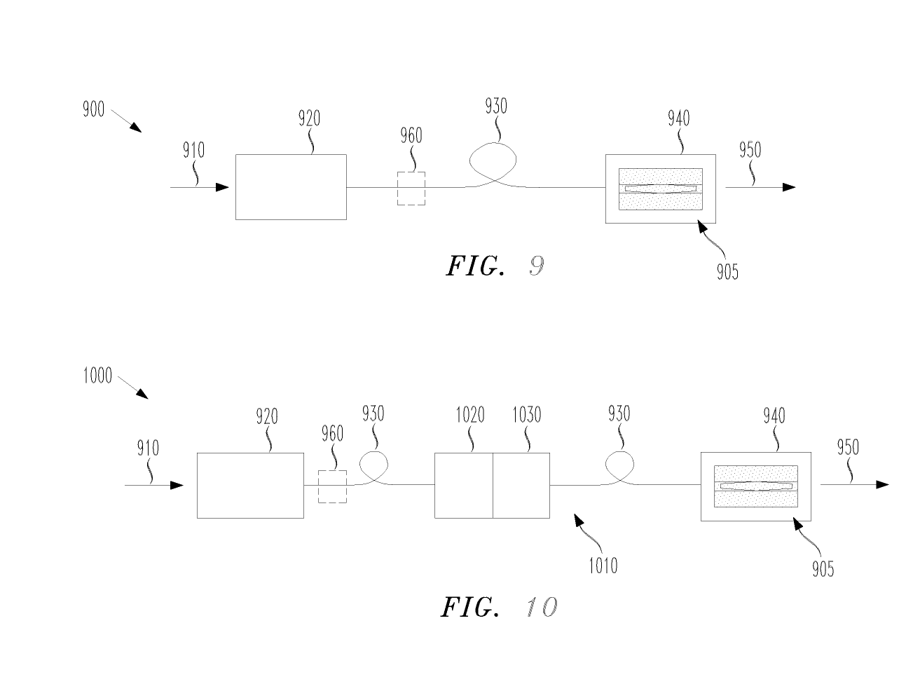

Turning now to FIG. 9, illustrated is a plan view of an optical communications system 900, which may form one environment in which an apparatus 905 (e.g., similar to one of the apparatus 100, 200 or 300) may be used. An initial signal 910 enters a transceiver 920 of the optical communications system 900. The transceiver 920, receives the input data signal 910, modulates the data signal 910 onto an optical carrier and sends the resulting information-carrying optical carrier across an optical fiber 930 to a transceiver 940. The transceiver 940 receives the information-carrying optical carrier from the optical fiber 930, demodulates the information thereon from the optical carrier, and sends an output data signal 950. As illustrated in FIG. 9, the apparatus 905 may be included within the transceiver 940. The apparatus 905 may also be included anywhere in the optical communications system 900, including the transceiver 920. It should be noted that the optical communications system 900 is not limited to the devices previously mentioned. For example, the optical communications system 900 may include an element 960, such as a laser, diode, optical modulator, optical demodulator, optical amplifier, optical waveguide, photodetectors, or other similar device, which may also include the apparatus 905.

Turning briefly to FIG. 10, illustrated is an alternative optical communications system 1000, having a repeater 1010, including a second receiver 1020 and a second transmitter 1030 (e.g., collectively a transceiver), located between the transceiver 920 and the transceiver 940. As illustrated, the alternative optical communications system 1000 may also include the apparatus 905.

Although the present disclosure has been described in detail, those skilled in the art should understand that they can make various changes, substitutions and alterations herein without departing from the spirit and scope of the disclosure.

What is claimed is:

1. An apparatus, comprising:
an optical coupling structure disposed within a cladding region, wherein the optical coupling structure includes a first guiding portion and a second guiding portion;
the first guiding portion being located on a first plane and tapering from a first greater width to a first lesser width in a first direction; and
the second guiding portion being located on a second different plane and tapering from a second greater width to a second lesser width in a second opposite direction.

2. The apparatus of claim 1 wherein the first and second planes are parallel.

3. The apparatus of claim 1 wherein the first guiding portion has a first centerline and the second guiding portion has a second centerline, and wherein the first and second centerlines are located in a third plane different from the first and second planes.

4. The apparatus of claim 3 wherein the third plane is normal the first and second planes.

5. The apparatus of claim 1 wherein the first guiding portion adiabatically tapers in the first direction and the second guiding portion adiabatically tapers in the second opposite direction.

6. The apparatus of claim 1 wherein the first guiding portion includes a step-function taper in the first direction and the second guiding portion includes a step-function taper in the second opposite direction.

7. The apparatus of claim 1 wherein the first and second guiding portions comprise a material having a high index of refraction, and further including a material layer located between the first and second guiding portions, wherein the material layer has a lower index of refraction.

8. The apparatus of claim 1 wherein the first guiding portion has a first substantially fixed thickness and the second guiding portion has a second substantially fixed thickness.

9. The apparatus of claim 1 wherein the optical coupling structure comprises silicon.

10. The apparatus of claim 1 wherein the first guiding portion is proximate a core of a planar waveguide and the second guiding portion is proximate the core of an optical fiber, and further wherein the optical coupling structure, planar waveguide and optical fiber form at least a portion of an optical communications system.

11. A method for operating an apparatus, comprising:
sending an optical signal through a core of an optical fiber; and
coupling the optical signal from the core of the optical fiber to a core of a planar waveguide using an optical coupling structure disposed within a cladding region, the optical coupling structure including:
a first guiding portion being located on a first plane and tapering from a first greater width to a first lesser width in a first direction; and
a second guiding portion being located on a second different plane and tapering from a second greater width to a second lesser width in a second opposite direction.

12. The method of claim 11 wherein the first and second planes are parallel.

13. The method of claim 11 wherein the first guiding portion has a first centerline and the second guiding portion has a second centerline, and wherein the first and second centerlines are located in a third plane different from the first and second planes.

14. The method of claim 13 wherein the third plane is normal the first and second planes.

15. The method of claim 11 wherein the first guiding portion adiabatically tapers in the first direction and the second guiding portion adiabatically tapers in the second opposite direction.

16. The method of claim 11 wherein the first and second guiding portions comprise a material having a high index of refraction, and further including a material layer located between the first and second guiding portions, wherein the material layer has a lower index of refraction.

17. The method of claim 11 wherein the optical coupling structure comprises silicon.

18. A method for manufacturing an apparatus, comprising:
providing a first layer of high refractive index material over a substrate;
patterning the first layer of high refractive index material into a first guiding portion, the first guiding portion being located on a first plane and tapering from a first greater width to a first lesser width in a first direction;
forming a second layer of high index material over the first guiding portion; and
patterning the second layer of high refractive index material into a second guiding portion, the second guiding portion being located on a second different plane and tapering from a second greater width to a second lesser width in a second opposite direction.

19. The method of claim 18 further including forming a material layer over the first guiding portion prior to forming the second layer of high index material, the material layer having an index of refraction lower than the first or second layers of high refractive index material and located between the first and second guiding portions.

20. The method of claim 18 wherein the first and second layers of high refractive index material comprise silicon.
